(19) United States
(12) Patent Application Publication
(10) Pub. No.: US 2023/0243425 A1
(43) Pub. Date: Aug. 3, 2023

(54) Gaskets for High and Low-Pressure and High Temperature Applications

(71) Applicant: William James Scott, Mesa, AZ (US)

(72) Inventor: William James Scott, Mesa, AZ (US)

(21) Appl. No.: 17/588,239

(22) Filed: Jan. 29, 2022

(51) Int. Cl. F16J 15/08

(52) U.S. Cl. CPC F16J 15/0806

(57) ABSTRACT

Embodiments of the inventive subject matter are directed to gaskets that can be used in various extreme settings including high temperature, vacuum, and high-pressure settings. Gaskets are made using soft annealed metals including aluminum, copper, nickel, and steel. Upon fully tightening a fitting using a gasket of the inventive subject matter, the gasket’s material is brought into a full hardness condition from its original soft annealed state. Ports that are designed for use with gaskets of the inventive subject matter is also disclosed. These ports include a first hole having a first diameter and then a second hole that continues from the first, where the second hole has a second, smaller diameter. Material transitions from the first diameter to the second diameter by a radial fillet. The filleted surface is configured to interact with a gasket of the inventive subject matter to minimize leak pathways. Performance of gaskets of the inventive subject matter can be further improved by applying a coating of, e.g., tin, silver, or gold.

### FIELD OF THE INVENTION

The field of the invention is gaskets for high- and low-pressure gas lines.

### BACKGROUND

The background description includes information that may be useful in understanding the present invention. It is not an admission that any of the information provided in this application is prior art or relevant to the presently claimed invention, or that any publication specifically or implicitly referenced is prior art.

High pressure and vacuum lines are used in all kinds of contexts from automotive to HVAC to aerospace. There is a perpetual need to create connections between different fittings and ports to allow for the transport of gas or to maintain a vacuum. But any time there is a disruption in a gas line, there is an opportunity for leakage.

Efforts have been made in the past to address leaks by adding gaskets between fittings. And while generally effective, previous efforts to create gaskets leave ample room for improvement. For example, currently known gaskets fail to contemplate improvements to performance that can be achieved by making the gaskets from softer materials that can be hardened upon tightening. Older gasket technology similarly fails to contemplate precise torquing requirements that lead to a desired material transformation that minimizes leak pathways. Finally, older gaskets also fall short by failing to include, along with other inventive features, specific material coatings that further reduce leak pathways.

It has yet to be appreciated that gaskets for use in high pressure, low pressure, and high temperature settings can be improved to nearly eliminate leaks entirely.

### SUMMARY OF THE INVENTION

The present invention provides apparatus, systems, and methods directed to gasket and ports for high and low pressure and temperature fittings. In one aspect of the inventive subject matter, a gasket is contemplated, the gasket having: an annular body comprising a soft annealed metal, where the annular body has an outer edge having an outer diameter, an inner edge having an inner diameter, and an angled surface therebetween, and where the angled surface is conical.

In some embodiments, the angled surface is angled between 30° and 60° from a center line, and the angled surface can have a thickness of 0.028-0.034 inches. The soft annealed metal can include copper, nickel, aluminum, steel, or the like. The annular body can additionally be coated in at least one of silver, gold, and tin.

In another aspect of the inventive subject matter, a gasket and port system is contemplated, the system having: a gasket with an annular body comprising a soft annealed metal, where the annular body has an outer edge having an outer diameter, an inner edge having an inner diameter and an angled surface therebetween, where the angled surface is conical; a port having a body comprising a material having a hole, where the hole has a first diameter down to a first depth and a second diameter beyond the first depth and the material at the first diameter is joined to the material at the second diameter by a filleted surface, and where the filleted surface has a curvature defined by a radius.

In some embodiments, the radius is between 0.09375 and 1.625 inches. The port material can be aluminum, brass, steel, or the like, and the angled surface is angled between 30° and 60° from a center line. The angled surface can have a thickness of 0.028 –0.034 inches. In some embodiments, the soft annealed metal of the gasket comprises copper, nickel, aluminum, or steel. In some embodiments, the annular body of the gasket is coated in at least one of silver, gold, and tin.

One should appreciate that the disclosed subject matter provides many advantageous technical effects including improved connections between different high- and low-pressure lines that can operate across a wide range of temperatures with minimal risk of leaking.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 shows a gasket of the inventive subject matter.

FIG. 2 shows another view of the gasket.

FIG. 3 shows another view of the gasket.

FIG. 4 shows another view of the gasket.

FIG. 5 shows a gasket in a port.

FIG. 6 shows a gasket in a port with a fitting coupled to the port.

FIG. 7 shows an exploded view of a flared tube having flare fitting and a nut with a gasket therebetween.

FIG. 8 shows the components from FIG. 7 in a fully assembled configuration.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing measurements, lengths, diameters, or any other numerically quantifiable value used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment and also based on manufacturing or fabrication tolerances. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

Gaskets of the inventive subject matter are capable of creating a gas-tight seal between two components, such that high- or low-pressure lines do not leak gas when coupled with, e.g., other lines or ports. Gaskets disclosed in this application can withstand a wide range of pressures and temperatures and are also capable of creating seals in a variety of applications, including automotive, air and space, and so on. Low failure rates as well as low leak rates make gaskets of the inventive subject matter better than existing gaskets. Also disclosed in this application is a port that can be used with gaskets of the inventive subject matter where the port is designed to improve performance (e.g., minimize leaks) when used with such gaskets.

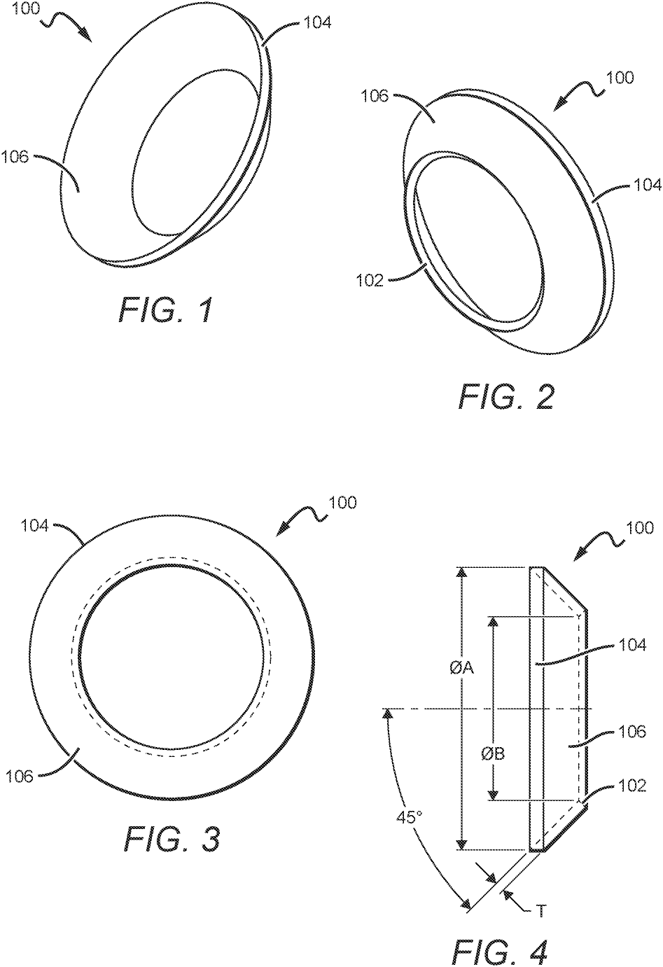

FIGS. 1 and 2 show gasket 100 from two isometric views, one from the front (FIG. 1) and one from the back (FIG. 2). Gasket 100 is annular in shape, having an inner edge 102 and an outer edge 104. Between inner edge 102 and outer edge 104 is a sloped portion 106. Sloped portion 106 is conical in shape and is configured to contact two surfaces when gasket 100 is used to create a seal—one surface on each component that the gasket is disposed between.

FIG. 3 shows a front view of gasket 100, with outer edge 104 and sloped portion 106 visible. Inner edge 102 is shown with dotted lines as it is slanted on gasket 100 such that it is not directly visible from a front view. This slant is not a necessary feature, and inner edge 102 can be slanted or unslanted, depending on the embodiment.

FIG. 4 shows a side view of gasket 100. From this view, several dimensions are visible that can describe the gasket. Outer diameter A describes an outer diameter of gasket 100, while inner diameter B describes an inner diameter of the annular region. Thickness T describes a thickness of sloped portion 106, which is disclosed to allow for variation of ±0.003 inches, though even more variation is also possible without deviating from the inventive subject matter. Although FIG. 4 shows sloped portion to be angled at 45° relative to a center line, it is also contemplated that this angle can range from 20° to 70°, depending on how the gasket it is to be used. These dimensions are described in more detail in Table A, below. Dimensions in Table A are in inches unless otherwise specified. Dimensions disclosed in Table A are subject to linear tolerances of +0.015/-0.000 inches and angular dimensions of ±0°30′. These tolerances are designed to prevent gaskets of the inventive subject matter from restricting a flow path of a gas or fluid within a line. Moreover, these tolerances are chosen to increase measurable part quality during inspection.

TABLE A

| Nominal Tube OD | Nominal Tube OD mm | ø″A″ ±0.03 | ø “B” MAX | T ±0.003 Material Thickness | Lb. /100 MAX Alum | Lb. /100 MAX Copper | Lb. /100 MAX Nickel | Lb. /100 MAX Cres |
|---|---|---|---|---|---|---|---|---|
| 3/16 | 4.76 | 0.31 | 0.12 | 0.031 | 0.026 | 0.084 | 0.08 | 0.075 |
| ¼ | 6.35 | 0.36 | 0.19 | 0.031 | 0.029 | 0.094 | 0.089 | 0.084 |
| 5/16 | 7.94 | 0.42 | 0.22 | 0.031 | 0.04 | 0.13 | 0.125 | 0.117 |
| ⅜ | 9.53 | 0.55 | 0.28 | 0.031 | 0.071 | 0.234 | 0.223 | 0.21 |
| ½ | 12.7 | 0.66 | 0.41 | 0.031 | 0.084 | 0.276 | 0.263 | 0.248 |
| ⅝ | 15.88 | 0.77 | 0.5 | 0.031 | 0.108 | 0.355 | 0.339 | 0.319 |
| ¾ | 19.05 | 0.95 | 0.62 | 0.031 | 0.165 | 0.543 | 0.518 | 0.488 |

Table A also includes additional information relevant to describing gaskets of the inventive subject matter. For example, nominal tube OD refers to outer diameters of, e.g., high pressure lines that gaskets of the inventive subject matter can be configured to accommodate. Columns describing “Lb./100” refers to the weight of each part measured in pounds force at sea level for four different materials (e.g., aluminum, copper, nickel, and CRES—corrosion resistant steel). Many different metals and metal alloys can be used to make gaskets of the inventive subject matter, and the list in Table A is not comprehensive. Each measurement described in the columns of Table A should also be considered as describing a series of a ranges of possible dimensions. For example, in the Nominal Tube OD column, measurements range from 3/16″ to ¾″, and so it should be understood that nominal tube ODs for gaskets of the inventive subject matter can range from 3/16″ to ¾″, capturing all measurements therebetween. This is true for each column describing a range of measurements. As for material thickness, it should be understood that thickness can vary by up to 20% from the listed thickness measurement without departing from the inventive subject matter.

Materials that make gaskets of the inventive subject matter, as mentioned in the bale above, can include aluminum, copper, nickel, and corrosion resistant steel. In some embodiments, gaskets can be made from titanium or austenitic nickel-chromium-based superalloys (e.g., Inconel). Where a material is disclosed, it should be understood that alloys incorporating that material or element (e.g., where at least a plurality of material in the alloy is the element) can also be used without deviating from the inventive subject matter. An example of an appropriate aluminum is type 1100-0 annealed aluminum sheet per AMS 4001; examples of appropriate coppers include types C10100, C10200, and C11000 cold-rolled annealed copper foil or strip, having a chemical composition per ASTM B152 and having mechanical properties per ASTM B152M; an example of an appropriate nickel is type N02201 cold-rolled annealed nickel sheet or strip per ASTM B162 or AMS 5553; and an example of an appropriate corrosion resistant steel includes type S30500 annealed corrosion resistant steel sheet or strip per ASTM A240.

In some embodiments, a gasket can be made from a material that is not significantly softer than the mating surfaces. In these embodiments, a 0.001” thick flash plating can be applied to the gasket to dramatically improve sealing performance. If platings much thicker than 0.001” are used, extrusion can occur, which can interfere with gas or fluid flow or cause leaks. It is therefore contemplated that plating thickness should not exceed 0.0015”

These materials can each be subject to heat treatments to improve their performance when formed into gaskets of the inventive subject matter. For example: aluminum gaskets can fully annealed per AMS 2770; copper can be bright annealed to full soft condition after formation at 1200° F. ± 25° F. for 45-60 minutes in a vacuum furnace with pyrometry in accordance with AMD 2750; nickel can be bright annealed to full soft condition after forming at 1500° F. ±25° F. for 30 to 60 minutes in a vacuum furnace with a gaseous nitrogen or argon quench and with pyrometric in accordance with AMS 2750; and corrosion resistant steel can be bright annealed after forming at 1950° F. ± 25° F. for 30 to 60 minutes in a vacuum furnace with a gaseous nitrogen or argon quench and with pyrometry in accordance with AMS 2750.

Different materials can provide different advantages relevant to gaskets of the inventive subject matter, and each material can further include a coating to improve its performance. Gasket materials can impact part compatibilities, operating temperatures, operating pressures, and leak minimization. Aluminum gaskets are compatible with fittings made from a variety of materials including aluminum and, when aluminum gaskets are coated in tin, silver, or gold, they become compatible with aluminum, brass, and steel fittings, too. Copper, nickel, and steels gaskets are compatible with brass and steel fittings, and, when coated in tin, silver, or gold, they become compatible with aluminum, brass, and steel fittings, too.

When discussing operating temperatures for different gaskets of the inventive subject matter, it should be understood that while a maximum operating temperature is disclosed explicitly, each gasket also has a minimum operating temperature of -420° F. and in some embodiments down to the freezing point of helium (-458° F.). Uncoated aluminum, uncoated copper, uncoated nickel, and uncoated steel gaskets can operate at temperatures up to 140° F. Aluminum, copper, nickel, and steel gaskets coated in tin can operate at temperatures up to 280° F. Aluminum, copper, nickel, and steel gaskets coated in either silver or gold can operate at temperatures up to 420° F.

Gaskets disclosed in this application are also configured to perform in different pressure ranges. For example, uncoated aluminum, uncoated copper, uncoated nickel, and uncoated steel can perform from a vacuum up to 500 PSI, while aluminum, copper, nickel, and steel coated in any of tin, silver, or gold can perform from a vacuum up to 3000 PSI. Titanium and Inconel can be used with fittings that support up to 50,000 PSI. At these high pressures, gaskets should be made from the same annealed material as the base port to create a functioning seal. In addition, when gaskets of the inventive subject matter are coated in tin, silver, or gold, those coatings: increase temperature performance, increase pressure performance, decrease galvanic coupling effects, increase fitting material compatibility, decrease leak rate for freon to 0 (e.g., helium can be sealed from leaking), and increase corrosion resistance. Examples of coating materials include, tin plate per MIL-T-10727 type 1 or AMS2408-2, silver matte (flash) per AMS2410K, and gold 24K 0.00050 thick per MIL-G-45204 C AM#3, TY III, class 5, grade A.

Because gaskets of the inventive subject matter are made from annealed aluminum, annealed copper, annealed nickel, or annealed steel, full material hardness for a given gasket can be achieved upon proper tightening. Thus, when two fittings (or a fitting and a port, etc.) are fully tightened together with a gasket of the inventive subject matter therebetween, the gasket material transforms from soft annealed to full hardness condition, thereby improving performance. Proper tightening is discussed in more detail below.

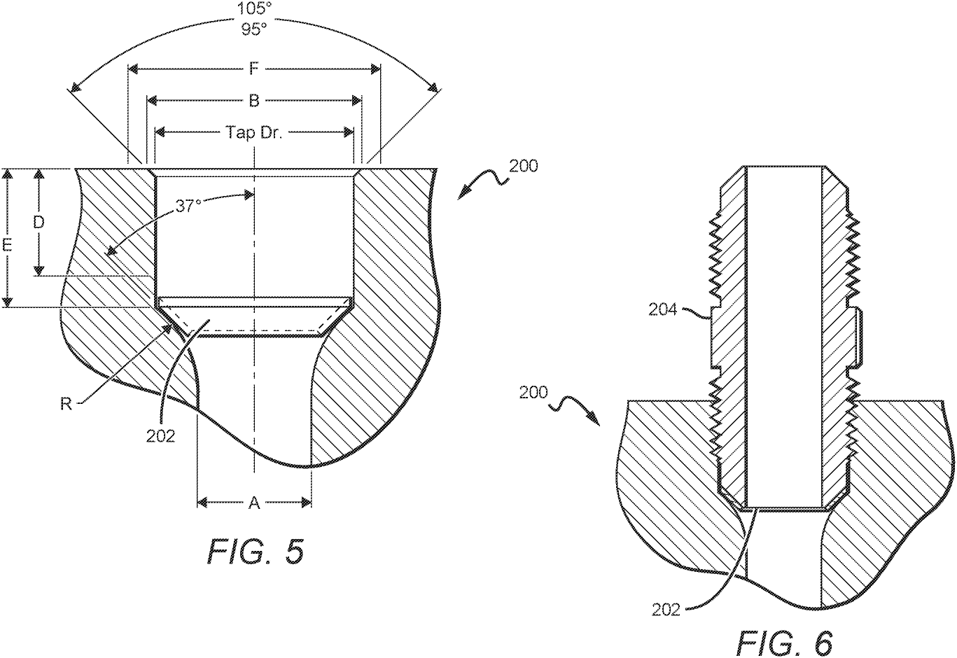

FIG. 5 shows a port that is specially designed for use with a gasket of the inventive subject matter. The port is shown with a gasket 202 placed therein. Port 200 comprises a hole having an inner diameter A, an outer chamfer diameter B, a gasket diameter C, a thread depth D, a tap depth E, an outer diameter F, and a tap fillet radius R. The filleted surface extends at a 45° relative to vertical at its topmost portion, and the filleted surface midway along its arc is 37° relative to vertical. Tables B and C show some possible dimensions for port 200 that gaskets of the inventive subject matter can be made to be compatible with. All dimensions in Tables B and C are in inches. The columns in Table C are a continuation of the columns in Table B.

TABLE B

| TUBE SIZE O.D. | THREAD SIZE | TAP DRILL SIZE |
|---|---|---|
| ⅛ | 5/16-24 UNF-3B | 0.272 |
| 3/16 | ⅜-24 UNF-3B | 0.332 |
| ¼ | 7/16-20 UNF-3B | 0.391 |
| 5/16 | ½-20 UNF-3B | 0.453 |
| ⅜ | 9/16-18 UNF-3B | 0.516 |
| ½ | ¾-16 UNF-3B | 0.688 |
| ⅝ | ⅞-14 UNF-3B | 0.813 |
| ¾ | 1-1/16-12 UNF-3B | 0.984 |
| 1 | 1-5/16-12 UNF-3B | 1.219 |
| 1-¼ | 1-⅝-12 UNF-3B | 1.5 |
| 1-½ | 1-⅞-12 UNF-3B | 1.813 |
| 1-¾ | 2-¼-12 UNF-3B | 2.188 |
| 2 | 2-½-12 UNF-3B | 2.438 |
| 2-½ | 3-12 UNF-3B | 2.875 |
| 3 | 3.1/2-12 UNF-3B | 3.375 |

TABLE C

| Ø A | Ø B | ∅ C | D MIN. | E | Ø F MIN. | R |
|---|---|---|---|---|---|---|
| 0.059-.065 | 0 .313-0.333 | 0.192-0.212 | 0.252 | 0.325-0.345 | 0.672 | 0.09375 |
| 0.122-0.128 | 0.375-0.395 | 0.255-0.275 | 0.283 | 0.356-0.376 | 0.75 | 0.125 |
| 0.169-0.175 | 0.438-0.458 | 0.310-0.330 | 0.332 | 0.422-0.442 | 0.828 | 0.15625 |
| 0.231-0.237 | 0.500-0.520 | 0.372-0.392 | 0.332 | 0.422-0.442 | 0.906 | 0.1875 |
| 0.293-0.301 | 0.562-0.582 | 0.431-0.451 | 0.33 | 0.431-0.451 | 0.969 | 0.21875 |
| 0.387-0.395 | 0.750-0.770 | 0.609-0.629 | 0.371 | 0.486-0.506 | 1.188 | 0.3125 |
| 0.481-0.488 | 0.875-0.895 | 0.722-0.742 | 0.453 | 0.586-0.606 | 1.344 | 0.375 |
| 0.605-0.613 | 1.062-1.082 | 0.899-0.919 | 0.501 | 0.658-0.678 | 1.625 | 0.5 |
| 0.839-0.851 | 1.312-1.332 | 1.148-1.168 | 0.548 | 0.705-0.725 | 1.91 | 0.5625 |
| 1.074-1.086 | 1.625-1.645 | 1.458-1.478 | 0.544 | 0.701-0.721 | 2.27 | 0.75 |
| 1.308-1.320 | 1.875-1.895 | 1.710-1.730 | 0.658 | 0.815-0.835 | 2.56 | 0.875 |
| 1.543-1.557 | 2.250-2.270 | 2.085-2.105 | 0.71 | 0.867-0.887 | 3.01 | 1 |
| 1.777-1.791 | 2.500-2.520 | 2.333-2.353 | 0.825 | 0.982-1.002 | 3.48 | 1.1875 |
| 2.277-2.291 | 3.000-3.020 | 2.729-2.749 | 0.67 | 0.827-0.847 | 3.9 | 1.375 |
| 2.777-2.791 | 3.500-3.520 | 3.229-3.249 | 0.748 | 0.905-0.925 | 4.5 | 1.625 |

Each measurement described in the columns of Tables B and C should also be considered as describing a series of a ranges of possible dimensions. For example, in the tube size OD column, measurements range from 3/16″ to ¾″, and so it should be understood that nominal tube ODs for gaskets of the inventive subject matter can range from 3/16″ to ¾″, capturing all measurements therebetween. This is true for each column describing a range of measurements. FIG. 6 shows a flare fitting as described above regarding FIG. 5 when it is tightened down into a port block with a gasket of the inventive subject matter positioned between the port block and the flare fitting.

The port shown in FIG. 5 is designed to create better seals, especially when used in association with a gasket of the inventive subject matter, as shown in FIG. 6. A conical sealing surface at the base of an ordinary port (e.g., one that does not feature a rounded, filleted surface as in port 200) is one potential leak path. Some causes of leaks include machining defects, out of round condition, nicks or creases due to previous fitting installation, and removal and compression from fitting over-torque. This problem is solved by incorporating a rounded, filleted surface at the base of port 200 (as described by radius R). This allows for variously angled fittings to be inserted and sealed in the port using a gasket of the inventive subject matter. Gasket 202 used with port 200 as shown in FIG. 5 protects the curved surface at the base of the port and allows for up to ±2° of angular misalignment by forming gasket 202 to the sealing surface upon proper primary and secondary torquing (as described below in more detail). The filleted surface at the base of port 200 allows the port to accommodate, e.g., both 37° and 24° fittings when a suitably angled gasket is also used. In some embodiments, fittings ranging from 20° to 45° are also compatible when used with a suitably angled gasket and filleted port surface.

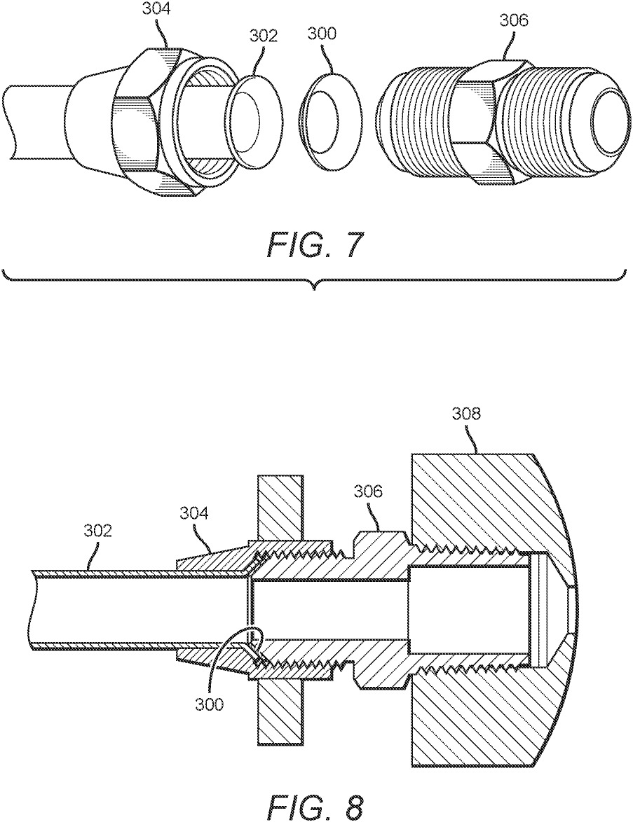

FIGS. 7 and 8 show a gasket used with a 45-degree flare tube. FIG. 7 is an exploded view showing gasket 300 between a flared tube 302 and a flare fitting 306. Flare fitting 306 is threaded so that flare nut 304 can couple thereto. When flare nut 304 is tightened onto flare fitting 306, gasket 300 is compressed between flared tube 302. FIG. 8 shows the components of FIG. 7 in a tightened state and coupled with a port block 308. Flare nut 304, when tightened onto flare fitting 306, interacts with the flared portion of flared tube 302, causing gasket 300 to be compressed between the flared portion of flared tube 302 and flare fitting 306. Flare fitting 306 is shown coupled with port block 308, where port block 308 is like the one described in FIG. 5.

To maximize gasket performance, components having gaskets should be tightened according to the specifications described in Table D. Table D therefore shows tightening specifications for a range of tube diameters (“Nom. Tube OD”) in association with different threading specifications for the fitting or ports associated therewith. Finally, torque (A) applies when flared tube, connector, or nut are aluminum, torque (B) applies when flared tube or brazed ferrule and connector are steel, and torque (C) applies for nickel gasket seals used with steel fittings. When a gasket is used in association with brass fittings, the torque required for full tightening is 75% of the values listed below for (B) and (C).

TABLE D

| Nom. Tube OD (inches) | Thread T AS8879 | Torque (A) Ibf-in | Torque (B) and (C) 1Ibf-in |
|---|---|---|---|
| 0.125 | 0.3125-24UNJF-3B | 22-30 | 35-50 |
| 0.188 | 0.3750-24UNJF-3B | 30-45 | 75-100 |
| 0.250 | 0.4375-20UNJF-3B | 40-60 | 115-150 |
| 0.312 | 0.5000-20UNJF-3B | 55-75 | 150-200 |
| 0.375 | 0.5625-18UNJF-3B | 75-115 | 250-300 |
| 0.438 | 0.6250-18UNJF-3B | 95-140 | 300-350 |
| 0.500 | 0.7500-16UNJF-3B | 150-225 | 450-500 |
| 0.562 | 0.8125-16UNJF-3B | 175-270 | 550-600 |
| 0.625 | 0.8750-14UNJF-3B | 200-315 | 650-700 |
| 0.688 | 1.0000-12UNJF-3B | 260-405 | 800-900 |
| 0.750 | 1.0625-12UNJF-3B | 300-450 | 900-1000 |
| 0.875 | 1.1875-12UNJF-3B | 360-540 | 1050-1200 |
| 1.000 | 1.3125-12UNJF-3B | 500-630 | 1200-1400 |
| 1.125 | 1.5000-12UNJF-3B | 540-745 | 1400-1700 |
| 1.250 | 1.6250-12UNJF-3B | 600-810 | 1500-1800 |
| 1.500 | 1.8750-12UNJF-3B | 700-1000 | 1900-2200 |
| 1.750 | 2.2500-12UNJF-3B | 800-1150 | 2200-2700 |
| 2.000 | 2.5000-12UNJF-3B | 850-1300 | 2500-3000 |

To properly apply torque using the specifications described in Table D, torque is applied in two steps. In a first step, a fitting or nut is turned (e.g., coupling it to a nut, port, fitting, or the like, as appropriate) until the applied torque reaches a specified range according to nominal tube outer diameter, threading, and fitting materials. Next, an amount of time is allowed to elapse, e.g., 10-15 seconds. In some embodiments, 5-30 seconds can be allowed to elapse, depending on factors including material properties and part sizes. Once that amount of time has elapsed allowing the materials (e.g., the gasket, the fittings/nut/port, or any combination thereof) to relax, torque is applied to the fitting or nut again to bring it back to the specified torque range. This process brings the gasket to a fully-hardened state, maximizing its performance.

As with other tables described in this application, it should be understood that each measurement described in the columns of Table D should also be considered, where appropriate, as describing a series of a ranges of possible dimensions. For example, in the Nominal Tube OD column, measurements range from 0.125″ to 2″, and so it should be understood that nominal tube ODs for gaskets of the inventive subject matter can range from 0.125″ to 2″, capturing all measurements therebetween. This is true for each column describing a range of measurements.

Thus, specific devices, systems, and methods directed to gaskets and ports that minimize leaks for high- and low-pressure applications have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A gasket comprising:
an annular body comprising a soft annealed metal;
wherein the annular body has an outer edge having an outer diameter, an inner edge having an inner diameter, and an angled surface therebetween; and
wherein the angled surface is conical.

2. The gasket of claim 1, wherein the angled surface is angled between 30° and 60° from a center line.

3. The gasket of claim 1, wherein the angled surface has a thickness of 0.028-0.034 inches.

4. The gasket of claim 1, wherein the soft annealed metal comprises copper.

5. The gasket of claim 1, wherein the soft annealed metal comprises nickel.

6. The gasket of claim 1, wherein the soft annealed metal comprises aluminum.

7. The gasket of claim 1, wherein the soft annealed metal comprises steel.

8. The gasket of claim 1, wherein the annular body is coated in at least one of silver, gold, and tin.

9. A gasket and port system, comprising:
the gasket having:
an annular body comprising a soft annealed metal;
wherein the annular body has an outer edge having an outer diameter, an inner edge having an inner diameter, and an angled surface therebetween; and
wherein the angled surface is conical.
the port comprising:
a body comprising a material having a hole;
wherein the hole has a first diameter down to a first depth and a second diameter beyond the first depth;
wherein the material at the first diameter is joined to the material at the second diameter by a filleted surface; and
wherein the filleted surface has a curvature defined by a radius.

10. The gasket and port system of claim 9, wherein the radius is between 0.09375 and 1.625 inches.

11. The gasket and port system of claim 9, wherein the material comprises at least one of aluminum, brass, and steel.

12. The gasket and port system of claim 9, wherein the angled surface is angled between 30° and 60° from a center line.

13. The gasket and port system of claim 9, wherein the angled surface has a thickness of 0.028-0.034 inches.

14. The gasket and port system of claim 9, wherein the soft annealed metal comprises copper.

15. The gasket and port system of claim 9, wherein the soft annealed metal comprises nickel.

16. The gasket and port system of claim 9, wherein the soft annealed metal comprises aluminum.

17. The gasket and port system of claim 9, wherein the soft annealed metal comprises steel.

18. The gasket and port system of claim 9, wherein the annular body is coated in at least one of silver, gold, and tin.
